(19) United States
(12) Patent Application Publication
(10) Pub. No.: US 2006/0222809 A1
(43) Pub. Date: Oct. 5, 2006

(54) Optical recording medium

(75) Inventors: Takashi Yamada, Tokyo (JP); Tsuyoshi Komaki, Tokyo (JP); Kenji Yamaga, Tokyo (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 11/387,716

(22) Filed: Mar. 24, 2006

(30) Foreign Application Priority Data
Mar. 29, 2005 (JP) 2005-094728

(51) Int. Cl. B32B 3/02

(52) U.S. Cl. 428/64.4

(57) ABSTRACT

An optical recording medium includes a recording layer provided on a substrate. The recording layer includes first and second information layers and a spacer layer therebetween. The optical recording medium also includes a warpage adjusting layer provided on the side of the substrate opposite to the recording layer to reduce the warpage of the spacer layer caused by curing. A moisture proof layer is formed on the surface of the warpage adjusting layer opposite to the recording layer to reduce the warpage of the warpage adjusting layer caused by moisture absorption and releasing by the warpage adjusting layer.

### BACKGROUND OF THE INVENTION

1. Field of the Invention

The present invention relates to an optical recording medium that has a stable warpage amount regardless of environmental changes.

2. Description of the Related Art

Optical discs suitable for the system using the blue laser light technology has been developed as optical recording media having a storage capacity larger than that of a DVD (Digital Versatile Disc).

In such an optical disc, the recording reproducing wavelength λ is set to 405 nm and the objective lens numerical aperture NA of the pickup head is raised to 0.85, so that the storage capacity can be as large as 25 GB. However, with the large NA value, the distance between the objective lens and the optical disc is as short as approximately 150 μm.

As a result, abrupt vibrations in a recording and reproducing apparatus or the warpage or surface sway of the disc could cause the pickup head and the optical disc to contact with each other.

A light transmitting layer having a thickness of 0.1 mm is provided on a substrate having a thickness of 1.1 mm in an optical disc, and therefore the disc has an asymmetrical structure as compared to the DVD. Therefore, the disc is more likely to suffer from warpage caused by environmental changes (in temperature and humidity).

The generated warpage could deform the optical disc, which causes the optical disc and the pickup head to collide with each other, and the recording or reproducing could probably be adversely affected.

In this case, the light transmitting layer is composed of a UV curable resin coated by spin coating, and therefore the optical disc suffers from warpage caused by shrinkage on curing. In order to eliminate the warpage, a warpage adjusting layer of a UV curable resin is provided on the back side of the substrate (the opposite side to the light-incident side).

Furthermore, as disclosed in the publication of Japanese Patent No. 3086501, in order to reduce the warpage of an optical disc caused by moisture absorption by the disc, a sputtering film of SiO₂ is formed as a moisture proof penetration film or a moisture proof penetration film made of an acrylic urethane-based UV curable resin and polyvinylidene chloride is formed.

A multi-layer optical recording medium having two or more recording layers has a spacer layer between the recording layers in addition to the above described light transmitting layer. This spacer layer is made of a hard UV curable resin with a high glass transition point Tg.

This can prevent cracks from being formed in a recording film when the recording film is deposited on the spacer layer.

However, when the hard resin spacer layer is provided between the recording layers, the optical recording medium greatly warps. Therefore the warpage adjusting layer is provided as described above to adjust the warpage of the optical recording medium.

For the warpage adjusting layer, acrylic polyurethane-based UV curable resin, for example, is used as disclosed in the publication of Japanese Patent No. 3086501.

However, the warpage adjusting layer has an expansion/shrink property as it absorbs or releases moisture, and therefore the layer expands/shrinks with environmental changes, which causes the optical disc to warp.

### SUMMARY OF THE INVENTION

In view of the foregoing problems, various exemplary embodiments of this invention provide an optical recording medium having reduced disc warpage caused by moisture absorption into, and release from, the warpage adjusting layer.

By diligent studies by the inventor, it has been found that a resin layer covered with a sputtering film does not contribute to warp caused by the moisture absorption/releasing, and the use of a moisture proof layer on the outer side of the warpage adjusting layer can reduce such warpage caused by moisture absorption/releasing into/from the warpage adjusting layer.

In summary, the above-described objectives are achieved by the following embodiments of the present invention.

(1) An optical recording medium comprising: a substrate; a recording layer and a light transmitting layer provided on one surface of the substrate; a warpage adjusting layer provided on the other surface of the substrate; and a moisture proof layer provided on the warpage adjusting layer.

(2) The optical recording medium according to (1), wherein the warpage adjusting layer is formed of a UV curable resin.

(3) An optical recording medium comprising: a substrate; a recording layer provided on one surface of the substrate and including at least two information layers and a spacer layer provided between the information layers, the spacer layer being formed of a UV curable resin; a light transmitting layer provided on the recording layer; a warpage adjusting layer provided on the other surface of the substrate; and a moisture proof layer provided on the warpage adjusting layer.

(4) The optical recording medium according to (3), wherein the spacer layer comprises: a transfer layer formed of a UV curable resin having a glass transition point Tg of at least 80° C.; and an adhesion layer formed of a UV curable resin having a glass transition point Tg of less than 100° C., the adhesion layer adhering the transfer layer to the information layer.

(5) The optical recording medium according to any one of (1) to (4), further comprising a label printing layer provided on a surface of the moisture proof layer opposite to the warpage adjusting layer.

(6) The optical recording medium according to (5), further comprising a warpage preventing layer provided between the moisture proof layer and the label printing layer, for keeping moisture absorption to and releasing from the light transmitting layer in balance.

According to the invention, a moisture proof layer is provided on the warpage adjusting layer prone to have warpage caused by moisture absorption/releasing, and therefore the warpage caused by moisture absorption/releasing can be prevented.

### BRIEF DESCRIPTION OF THE DRAWINGS

FIG. 1 is an enlarged schematic cross-sectional view of an optical recording medium according to a first exemplary embodiment of the invention;

FIG. 2 is a graph showing the state of changes in the warpage angles caused by humidity changes in the optical recording media according to the first exemplary embodiment and a Comparative Example;

FIG. 3 is an enlarged schematic view of an optical recording medium according to a second exemplary embodiment of the invention;

FIG. 4 is an enlarged schematic view of an optical recording medium according to a third exemplary embodiment of the invention;

FIG. 5 is an enlarged schematic view of an optical recording medium according to a fourth exemplary embodiment of the invention; and

FIG. 6 is a graph showing changes in the warpage angles caused by humidity changes in Examples 1 and 2 actually produced according to the invention and Comparative Examples 1 and 2 having a warpage adjusting layer and a moisture proof layer in positions reversed from those of the optical recording media according to the invention.

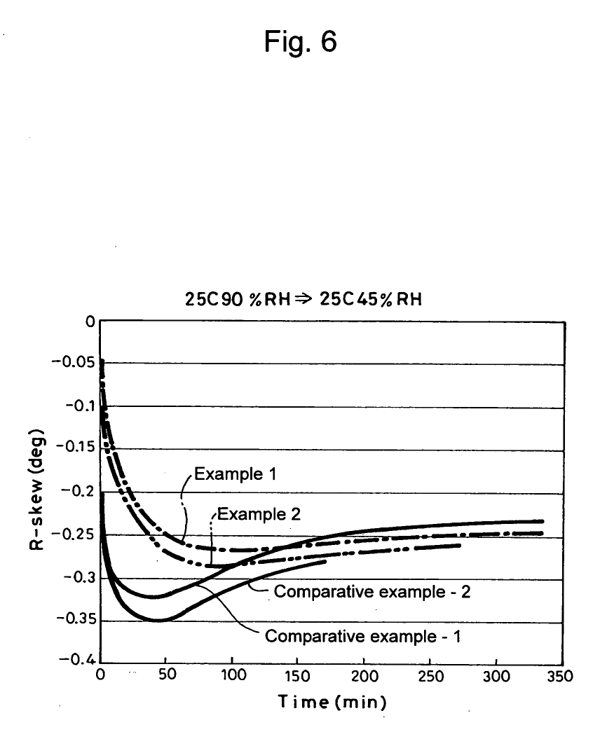

### DETAILED DESCRIPTION OF THE PREFERRED EMBODIMENTS

The optical recording medium includes a substrate, a recording layer provided on the light-incident side of the substrate, a light transmitting layer provided on the light-incident side of the recording layer, and a warpage adjusting layer and a moisture proof layer provided in order on the light-incident side of the substrate and the opposite side. The recording layer includes a first information layer provided on the light-incident side of the substrate, at least one semi-transparent information layer provided on the light-incident side of the first information layer and including a semi-transparent recording film, and spacer layers provided between the first information layer and the semi-transparent information layer and between the semi-transparent information layers. The first information layer and the recording film in the semi-transparent layer each are of a sputtering film. The spacer layer is composed of a UV curable resin. The moisture proof layer is of a sputtering film, and the warpage adjusting layer is configured to reduce the warpage of the substrate caused by the curing of the spacer layers.

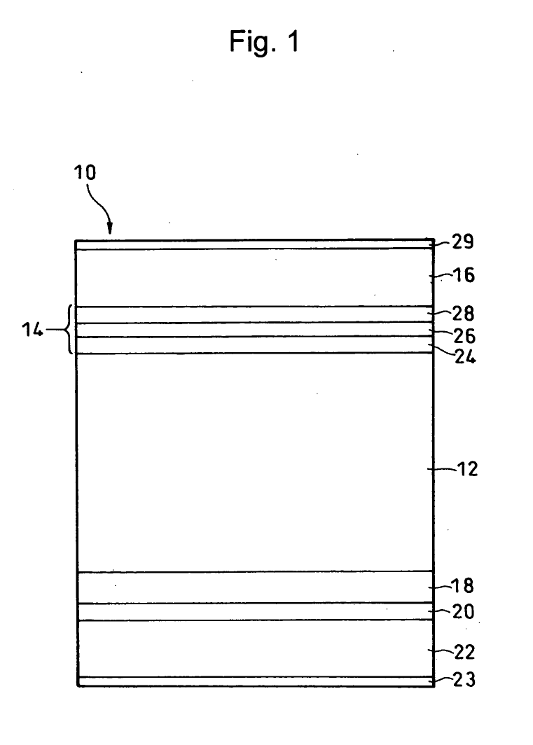

Now, referring to FIG. 1, an optical recording medium 10 according to a first exemplary embodiment of the invention (so-called two-layer optical recording medium having two information layers that form a recording layer) will be described in detail.

The optical recording medium 10 includes a substrate 12, a recording layer 14 provided on one surface (on the light-incident side) of the substrate 12, a light transmitting layer 16 provided on the light-incident side of the recording layer 14, and a warpage adjusting layer 18, a moisture proof layer 20, a warpage preventing layer 22, and a label printing layer 23 provided on the other surface of the substrate 12 (on the side opposite to the light-incident side) in the order mentioned.

The recording layer 14 includes a first information layer 24 provided on the light-incident side of the substrate 12, a second information layer 28 as a semi-transparent film provided on the light-incident side of the first information layer 24, and a spacer layer 26 provided between the first and second information layers 24 and 28 to separate the layers included in the recording layer.

The first and second information layers 24 and 28 in the recording layer 14 are made of sputtering films and the spacer layer 26 is composed of a UV curable resin.

The material and the thickness of each layer in the optical recording medium 10 are as follows.

The substrate 12 has a thickness of approximately 1.1 mm and is of a material such as polycarbonate resin and olefin resin. Meanwhile, the material of the substrate 12 may be any material that can support the recording layer and the light transmitting layer other than the above described materials. The reference numeral 29 in FIG. 1 indicates a hard coat layer which protects the light transmitting layer 16.

The second information layer 28 is made thinner than the first information layer 24 so that the second information layer is semi-transparent (for example having a light transmittance of 50%), and these layers each have a thickness in the range from 20 nm to 300 nm.

The first and second information layers 24 and 28 each include one or more functional layers depending on the usage. For a ROM (Read Only Memory) type medium, for example, the information layer is formed as a reflection layer of a material such as Al, Ag, and Au. For an RW (Re-Writable) type medium, the layer includes a reflection layer and layers such as a phase change material layer and a dielectric material layer. For an R (Recordable) type medium, the layer includes a reflection layer, a phase change material layer, and an organic dye layer such as a cyanine-based dye layer, a phthalocyanine-based dye layer, and an azo dye layer.

The light transmitting layer 16 (thickness: 30 μm to 100 μm), the warpage adjusting layer 18 (thickness: 1 μm to 60 μm), the warpage preventing layer 22 (thickness: 30 μm to 100 μm), and the spacer layer 26 (thickness: 10 μm to 30 μm) are made of a UV curable resin composition containing a photopolymerizable monomer, a photopolymerizable oligomer, a photoinitiator, and other additives, if desired.

Examples of photopolymerizable monomers for use in the ultraviolet curable resin composition include:

monofunctional compounds such as allyl (meth)acrylate, benzyl (meth)acrylate, butoxy(meth)acrylate, butadiol (meth)acrylate, butoxytriethylene glycol (meth)acrylate, ECH-modified butyl (meth)acrylate, tert-butylaminoethyl (meth)acrylate, caprolactone (meth)acrylate, 2-cyanoethyl(meth)acrylate, cyclohexyl(meth)acrylate, dicyclopentanyl(meth)acrylate, alicyclic modified neopentyl glycol (meth)acrylate, 2,3-dibromopropyl(meth)acrylate, dicyclopentenyl(meth)acrylate, dicyclopentenyloxy(meth)acrylate, N,N-diethylaminoethyl(meth)acrylate, 2-ethoxyethyl(meth)acrylate, 2-ethylhexyl(meth)acrylate, glycerol (meth)acrylate, glycidyl(meth)acrylate, heptadecafluorodecyl(meth)acrylate, 2-hydroxyethyl(meth)acrylate, caprolactone modified 2-hydroxyethyl(meth)acrylate, 2-hydroxypropyl(meth)acrylate, isobornyl(meth)acrylate, isodecyl(meth)acrylate, isooctyl(meth)acrylate, lauryl(meth)acrylate, methoxydiethylene glycol (meth)acrylate, methoxydipropylene glycol (meth)acrylate, morpholine (meth)acrylate, phenoxyethyl(meth)acrylate, phenoxyhydroxypropyl(meth)acrylate, EO-modified phenoxylated phosphonic acid-(meth)acrylate, phenyl(meth)acrylate, EO-modified phosphonic acid-(meth)acrylate, EO-modified phthalic acid-(meth)acrylate, polyethylene glycol 200 (meth)acrylate, polyethylene glycol 400 (meth)acrylate, polyethylene glycol 600 (meth)acrylate, stearyl(meth)acrylate, EO-modified succinic acid-(meth)acrylate, tetrafluoropropyl(meth)acrylate, tetrahydrofurfuryl(meth)acrylate, vinyl acetate, and N-vinylcaprolactam; and

multifunctional compounds such as (meth)acrylated isocyanurate, bis(acryloxyneopentyl glycol) adipate, EO-modified bisphenol A di(meth)acrylate, EO-modified bisphenol S di(meth)acrylate, EO-modified bisphenol F di(meth)acrylate, 1,4-butanediol di(meth)acrylate, 1,3-butylene glycol di(meth)acrylate, dicyclopentanyl di(meth)acrylate, diethylene glycol (meth)acrylate, dipentaerythritol hexa(meth)acrylate, dipentaerythritolmonohydroxy penta(meth)acrylate, alkyl-modified dipentaerythritol penta(meth)acrylate, alkyl-modified dipentaerythritol tetra(meth)acrylate, alkyl-modified dipentaerythritol tri(meth)acrylate, caprolactone-modified dipentaerythritol hexa(meth)acrylate, ditrimethylolpropane tetra(meth)acrylate, ethylene glycol di(meth)acrylate, ECH-modified glycerol tri(meth)acrylate, 1,6-hexanediol di(meth)acrylate, ECH-modified 1,6-hexanediol di(meth)acrylate, long chain aliphatic di(meth)acrylate, methoxylated cyclohexyl di(meth)acrylate, neopentyl glycol di(meth)acrylate, hydroxypivalate neopentyl glycol di(meth)acrylate, pentaerythritol tri(meth)acrylate, pentaerythritol tetra(meth)acrylate, stearic acid-modified pentaerythritol di(meth)acrylate, EO-modified phosphate di(meth)acrylate, polyethylene glycol di(meth)acrylate, polypropylene glycol di(meth)acrylate, tetraethylene glycol di(meth)acrylate, triethylene glycol (meth)acrylate, trimethylolpropane tri(meth)acrylate, EO-modified trimethylolpropane tri(meth)acrylate, PO-modified trimethylolpropane tri(meth)acrylate, tris((meth)acryloxyethyl) isocyanurate, and caprolactone-modified tris((meth) acryloxyethyl) isocyanurate.

Examples of photoinitiators include benzophenone, 2,4,6-trimethylbenzophenone, methyl-o-benzoyl benzoate, 4-phenylbenzophenone, diethoxyacetophenone, 2-hydroxy-2-methyl-1-phenylpropane-1-one, benzyldimethylketal, 1-hydroxycyclohexylphenylketone, 2-methyl-1-[4-(methylthio)phenyl]-2-morpholinopropane-1, benzoin methyl ether, benzoin ethyl ether, benzoin isopropyl ether, benzoin isobutyl ether, methylbenzoyl formate, and the like.

Examples of the photopolymerizable oligomers include urethane acrylate, epoxy acrylate, polyether acrylate, polyester acrylate, and the like.

In practice, among the UV curable resin compositions for the layers, the material for the spacer layer 26 must include a composition with a relatively high glass transition point Tg and a small linear expansion coefficient for fear that the recording film should suffer from cracks generated when depositing the film or due to temperature changes caused by environmental changes. Therefore, the composition mainly contains photopolymerizable monomers. The glass transition point Tg for the resin composition is desirably not less than 80° C., preferably not less than 100° C.

The warpage adjusting layer 18 has a relatively small thickness and still has to adjust warpage, and therefore the composition used for the layer 18 must mainly contain include multifunctional monomers with a high Tg and large cure shrinkage.

Since the light transmitting layer 16 has a relatively large thickness, the material used for the layer 16 should be selected so that the shrinkage ratio must be reduced to prevent warpage. Therefore, the composition must mainly contain photopolymerizable oligomers. A light transmitting sheet of the same kind of material as that of the substrate may be used.

The warpage preventing layer 22 preferably has the same composition and thickness as those of the light transmitting layer 16 so that warpage is balanced between the layer 22 and the light transmitting layer 16 upon the absorption/releasing of moisture. However, as long as the water absorption amount by the light transmitting layer 16 and the sum of the water absorption amounts by the warpage preventing layer 22 and the label printing layer 23 are substantially the same, they do not have to have the same composition and thickness. When the water absorption amounts of the label printing layer 23 and the light transmitting layer 16 are the same, the warpage preventing layer does not have to be provided.

The moisture proof layer 20 (thickness: 20 nm to 300 nm) can prevent water from coming in, and preferably includes at least one metal selected from the group consisting of Zn, Al, Ta, Ti, Co, Zr, Pb, Ag, Sn, Ca, Ce, V, Cu, Fe, Mg, B and Ba, or oxide, nitride, sulfide, fluoride containing any of these metals, or a dielectric material of a composite thereof.

The hard coat layer 29 (thickness: 0.5 μm to 5 μm) has a composition containing an active energy ray curable compound, and inorganic microparticles whose average grain size is not more than 100 nm. A resin composition containing the photopolymerizable monomers, the photo polymerizable oligomers, and the photoinitiators described above may be used as the active energy ray curable compound. The inorganic microparticles may be microparticles of metal (or semimetal) oxide or metal (or semimetal) sulfide and examples of the metals include Si, Ti, Al, Zn, Zr, In, Sn, Sb, and the like. In addition to the oxide and sulfide, selenide, telluride, nitride, and carbide may be used.

For the label printing layer 23 (thickness: 2 μm to 20 μm), a general-purpose UV curable or thermosetting printing ink can be used. Herein, the water absorption amount of the light transmitting layer (that equals to the water absorbing ratio multiplied by the volume) and the water absorption amount of the label printing layer 23 are preferably substantially equal to each other.

Now, the relation between the thickness and the hardness of the spacer layer and the warpage adjusting layer will be described.

The thickness of the spacer layer is in the range of from 10 μm to 30 μm. The thickness of the warpage adjusting layer may have any thickness as long as the warpage can be corrected, while it would be better if the warpage can be corrected by a layer as thin as possible. In this way, the material cost can be reduced. Furthermore, the total thickness and weight of the optical recording medium must be within specifications, and, for example, if the total thickness of the optical recording medium is too large, there can be a problem related to chucking operation at the drive. Therefore, the thickness of the warpage adjusting layer is in the range of from 1 μm to 60 μm, preferably in the range of from 1 μm to 20 μm.

The hardness (elasticity coefficient) of the spacer layer is preferably not less than 1 GPa at 25° C. for fear of forming cracks in the second recording layer.

Herein, the warpage of the optical recording layer in general is probably caused by internal stress in association with the curing of the UV curable resin. It is believed that the internal stress depends on the cure shrinkage when the UV curable resin cures, and the elasticity coefficient, the linear expansion coefficient, and the thickness of the cured material. It is also believed that as these values increase, the internal stress increases, which causes greater warpage in the optical recording medium.

Therefore, in order to make the thickness of the warpage adjusting layer smaller than that of the spacer layer, the elasticity coefficient of warpage adjusting layer must be set larger than that of the spacer layer, and the elasticity efficiency of the warpage adjusting layer is preferably at least 1 GPa at 25° C.

The internal stress of the warpage adjusting layer can be increased by increasing the cure shrinkage of the UV curable resin. In order to increase the cure shrinkage, the crosslink density of the curing material has only to be increased, which can be achieved by increasing the amount of multifunctional photopolymerizable monomers contained in the composition. However, if the cure shrinkage is increased too much, cracks form during curing or the adhesion with the base material can be insufficient, and therefore the cure shrinkage is preferably in the range of from 5% to 15%.

Herein, the cure shrinkage is represented as follows:
Cure shrinkage (%)=(D2−D1)/D2×100
where D1 represents the specific gravity of the liquid composition before curing at 25° C., and D2 represents the specific gravity of the cured material at 25° C.

Furthermore, the internal stress of the warpage adjusting layer can be increased by increasing the linear expansion coefficient thereof, while in consideration of a moisture proof layer to be formed on the warpage adjusting layer, the linear expansion coefficient cannot be too large for fear of cracks in the moisture proof layer. Therefore, the linear expansion coefficient of the warpage adjusting layer is preferably about 5 to 15×10⁻⁵/° C. and substantially the same as that of the spacer layer.

Therefore, as the method of increasing the internal stress of the warpage adjusting layer, in other words as the method of reducing the thickness of the warpage adjusting layer, the elasticity coefficient and the cure shrinkage of the cured material may be increased.

While the warpage adjusting layer has a smaller thickness, it is designed so that the internal stress of the spacer layer (in proportion to the elasticity×the thickness×the cure shrinkage) is equal to the internal stress of the warpage adjusting layer (in proportion to the elasticity coefficient×the thickness×the cure shrinkage).

Herein, ‘equalizing the internal stress’ refers to keeping the warpage of the disc (optical recording medium) provided with the warpage adjusting layer within 0.3 deg, and preferably within 0.2 deg.

In the optical recording medium 10 according to the first exemplary embodiment, the spacer layer 26 is inserted between the two information layers, not related to the warpage caused by absorption/releasing of moisture, and of hard resin having a high Tg. The warpage adjusting layer 18 is provided opposite to the spacer layer 26 with the substrate 12 interposed therebetween, and the moisture proof layer 20 is formed on the warpage adjusting layer 18. In this way, the absorption/releasing of moisture by the warpage adjusting layer 18 can be controlled, so that the entire recording medium 10 can be prevented from being warped.

According to the first exemplary embodiment, the warpage prevention layer 22 for keeping the absorption/releasing of moisture in balance is provided opposing the light transmitting layer 16, and therefore the light transmitting layer 16 can be prevented from being warped by the absorption/releasing of moisture, so that the warpage of the entire recording medium 10 can be reduced.

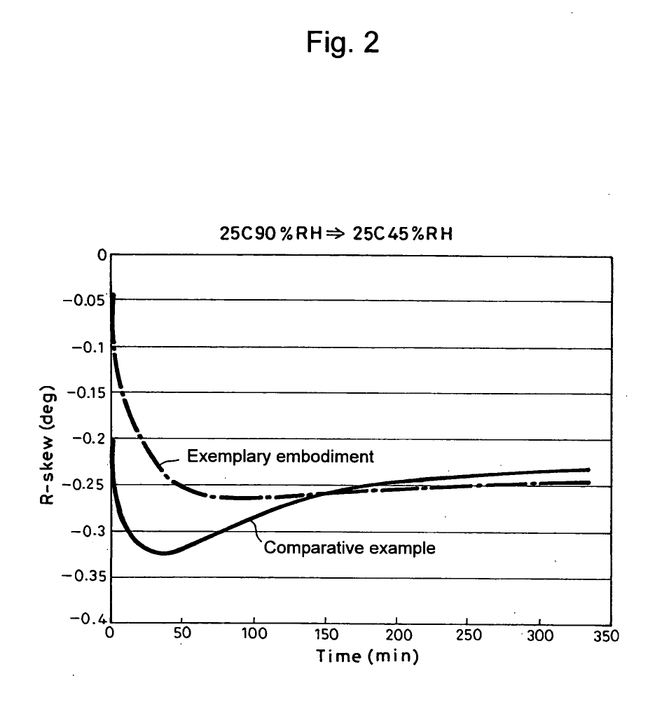

An optical recording medium according to a comparative example in which the warpage adjusting layer 18 and the moisture proof layer 20 are replaced from each other in the structure of the optical recording medium 10 according to the first exemplary embodiment and the optical recording medium according to the first exemplary embodiment were measured for changes in their warpage depending on temperature/humidity impact-moisture changes. The result is given in FIG. 2.

In the measurement condition in FIG. 2, the optical recording media according to the first exemplary embodiment and the comparative example were left to stand at 25° C. and with a relative humidity of 90% for 24 hours and then maintained in an environment at 25° C. and with a relative humidity of 45%. Then, the changes in their warpage were measured. In the graph, the abscissa represents time (min), and the ordinate represents the warpage angle (R-skew).

As can be understood from FIG. 2, the changes in the warpage of the optical recording medium according to the first exemplary embodiment due to changes in humidity are smaller and milder than those in the comparative example.

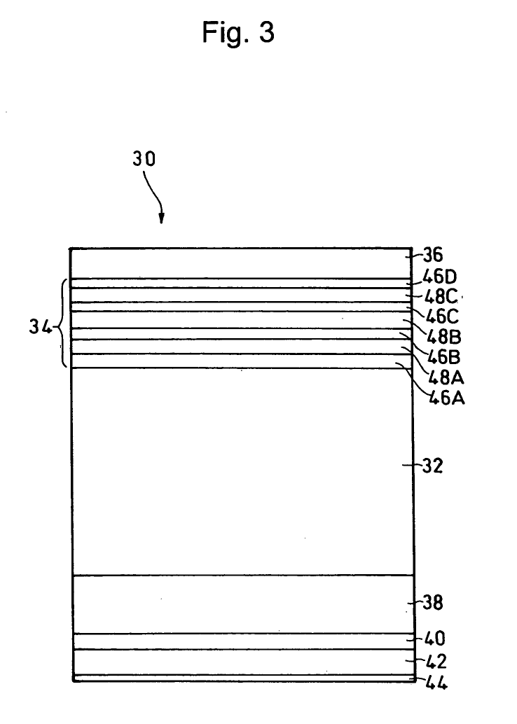

Now, referring to FIG. 3, an optical recording medium 30 (so-called four-layer optical recording medium having four information layers) according to a second exemplary embodiment of the invention will be described.

The optical recording medium 30 has a recording layer 34 that includes four layers, first to fourth information layers 46A to 46D having first to third spacer layers 48A to 48C inserted therebetween, respectively.

A substrate 32, a light transmitting layer 36, a warpage adjusting layer 38, a moisture proof layer 40, a warpage preventing layer 42, and a label printing layer 44 have the same structure as those in the optical recording medium 10 according to the first exemplary embodiment shown in FIG. 1.

However, the thickness of the warpage adjusting layer 38 is generally set to be equal to the sum of the thicknesses of the first to third spacer layers 48A and 48C. The moisture proof layer 40 functions in the same manner as the moisture proof layer 20 in the optical recording medium according to the first exemplary embodiment, and therefore will not be further described.

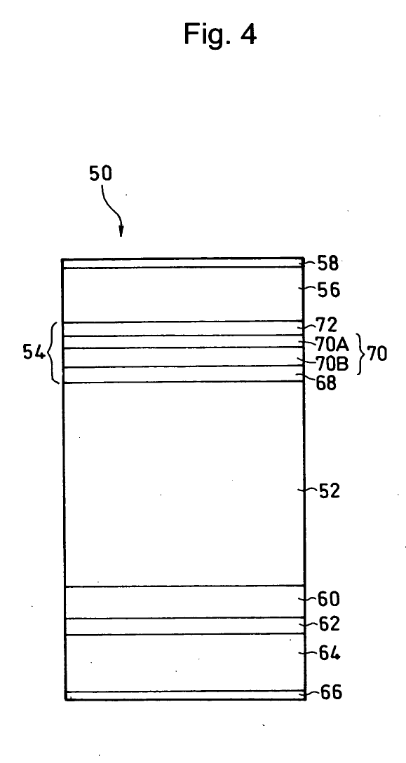

Now, an optical recording medium 50 according to a third exemplary embodiment of the invention shown in FIG. 4 will be described.

The optical recording medium 50 has a recording layer 54 including a first information layer 68, a spacer layer 70, and a second information layer 72. The spacer layer 70 is a two-layer structure including a transfer layer 70A to which a pattern of grooves or pits is transferred and an adhesion layer 70B used to adhere the transfer layer 70A and the first information layer 68.

The transfer layer 70A (thickness: 0.1 μm to 30 μm) and the adhesion layer 70B (thickness: 5 μm to 30 μm) are made of a UV curable resin composition containing the photopolymerizable monomers, photopolymerizable oligomers, photoinitiators described above, and other desired additives.

The material for the transfer layer 70A must have a relatively high Tg and a small linear expansion coefficient for fear of cracks in the recording film because of temperature changes caused during depositing the recording film or by environmental changes. Therefore, the material has a composition mainly containing a photopolymerizable monomer. The resin composition desirably has a Tg of at least 80° C., and preferably at least 100° C.

The material for the adhesion layer is preferably a composition mainly containing a photopolymerizable monomer with a low Tg and a photopolymerizable oligomer so that the layer has adhesion and flexibility, and the Tg of the resin composition is preferably less than 100° C., and preferably less than 80° C.

A substrate 52, a light transmitting layer 56, a hard coat layer 58, a warpage adjusting layer 60, a moisture proof layer 62, a warpage preventing layer 64, and a label printing layer 66 in the optical recording medium 50 have the same configurations as those of the substrate 12, the light transmitting layer 16, the warpage adjusting layer 18, the moisture proof layer 20, the warpage preventing layer 22, and the label printing layer 23, and therefore will not be further described.

In the optical recording medium 50 according to the third exemplary embodiment, in addition to the effect brought about by the first exemplary embodiment, the thickness of the warpage adjusting layer necessary for reducing the warpage of the entire recording medium can be reduced by the reduced amount of the internal stress of the adhesion layer since the spacer layer 70 has a two-layer structure including the transfer layer with a high Tg and the adhesion layer with a low Tg.

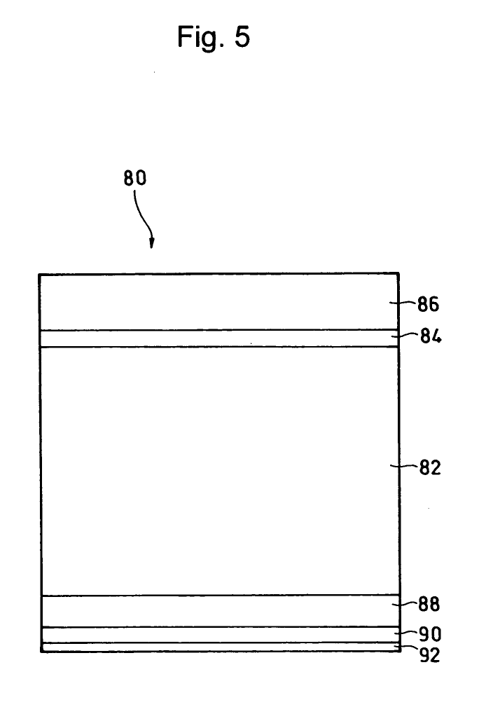

Now, referring to FIG. 5, an optical recording medium 80 according to a fourth exemplary embodiment of the invention (so-called single layer optical recording medium having one information layer as a recording layer) will be described.

The optical recording medium 80 includes a substrate 82, a recording layer 84 provided on the light-incident side of the substrate 82, a light transmitting layer 86 provided on the recording layer 84, and a warpage adjusting layer 88, a moisture proof layer 90, and a label printing layer 92 provided in order mentioned on the side opposite to the light-incident side of the substrate 82.

The substrate 82, the light transmitting layer 86, the warpage adjusting layer 88, the moisture proof layer 90, and the label printing layer 92 in the optical recording medium 80 have the same configurations as those of the substrate 12, the light emitting layer 16, the warpage adjusting layer 18, the moisture proof layer 20, and the label printing layer 23 in the first exemplary embodiment described above and therefore will not further be described. The recording layer 84 has the same configuration of the first information layer 24 in the first exemplary embodiment.

In the optical recording medium 80 according to the fourth exemplary embodiment, the warpage adjusting layer 88 is provided on the opposite side to the light transmitting layer 86 through the substrate 82 interposed therebetween, and the moisture proof layer 90 is provided thereon. The moisture absorbing/releasing by the warpage adjusting layer 88 made of a hard resin having a high Tg can be controlled, so that the entire recording medium can be prevented from being warped because of moisture absorbing/releasing.

According to the fourth exemplary embodiment, since the warpage adjusting layer 88 of a hard resin having a high Tg is provided opposing the light transmitting layer 86, the thickness can be reduced and the material cost can be reduced as compared to the case in which the layer of the same material as the light transmitting layer 86 and having the same thickness is opposed to the light transmitting layer 86 for preventing warpage.

In the fourth exemplary embodiment, since the label printing layer 92 that absorbs water substantially as much as the light transmitting layer 86 is provided opposing the light transmitting layer 86, the warpage of the light transmitting layer 86 caused by moisture absorption/removal can be reduced, which can reduce the warpage of the entire recording medium.

### EXAMPLES

Now, an example of an optical recording medium produced in the same manner as the exemplary embodiments of the invention will be described.

A polycarbonate substrate having a thickness of 1.1 mm and an outer diameter of 120 mm was produced by injection molding. There were pits and grooves on the substrate.

A first information layer was deposited on the surface of the polycarbonate substrate by sputtering. More specifically, a reflection layer having a thickness of approximately 100 nm and composed of a material containing Al, Pd, and Cu in a mixing ratio of 98 (Al): 1(Pd): 1(Cu), a dielectric layer having a thickness of approximately 40 nm and composed of a material containing ZnS (zinc sulfide) and SiO₂ (silicon dioxide) in a mixing ratio of 80 (ZnS): 20(SiO₂), an alloy layer having a thickness of approximately 5 nm and composed of a material containing Cu, Al, and Au in a mixing ratio of 64 (Cu): 23(Al): 23(Au), a protective layer having a thickness of approximately 5 nm and composed of Si, and a dielectric layer having a thickness of approximately 20 nm and composed of the same material as the above dielectric layer were formed in this order mentioned.

An adhesion layer having a thickness of approximately 15 μm was formed on the first information layer. The UV curable resin composition for the adhesion layer included 40% by mass of urethane acrylate (manufactured by TOAGOSEI CO., LTD. under the trade name of “M-1200”), 13% by mass of polyethylene glycol diacrylate (with a number average molecular weight of 200)(manufactured by KYOEISHA CHEMICAL Co., LTD. under the trade name of “4EG-A”), 10% by mass of EO-modified bisphenol A type diacrylate (manufactured by NIPPON KAYAKU Co., LTD. under the trade name of “KAYARAD R-551”), 22% by mass of 2-hydroxy-3-phenoxylpropyl acrylate (manufactured by TOAGOSEI CO., LTD under the trade name of “M-5700”), 12% by mass of tetrahydrofurfuryl acrylate (manufactured by KYOEISHA CHEMICAL Co., LTD. under the trade name of “THF-A”), and 3% by mass of 1-hydroxycyclohexylphenylketone (manufactured by Ciba Specialty Chemicals Corporation under the trade name of “IRG184”).

A transfer layer having a thickness of approximately 10 μm was formed on the adhesion layer as the spacer layer. At the time, pits and grooves were transferred on the transfer layer.

Note that the UV curable resin composition used for the transfer layer included 57% by mass of ECH-modified 1,6-hexanediol diacrylate (manufactured by NIPPON KAYAKU Co., LTD. under the trade name of “KAYARAD R-167”), 30% by mass of trimethylolpropane triacrylate (manufactured by NIPPON KAYAKU Co., LTD under the trade name of “KAYARAD TMPTA”), 10% by mass of tetrahydrofurfuryl acrylate (manufactured by KYOEISHA CHEMICAL Co., LTD. under the trade name of “THF-A”), and 3% by mass of 1-hydroxycyclohexylphenylketone (manufactured by Ciba Specialty Chemicals Corporation under the trade name of “IRGI184”).

A second information layer was deposited on the spacer layer by sputtering. More specifically, a dielectric layer having a thickness of approximately 25 nm and composed of a material containing ZnS (zinc sulfide)and SiO₂ (silicon dioxide) in a mixing ratio of 80 (ZnS): 20(SiO₂), an alloy layer having a thickness of approximately 5 nm and composed of a material containing Cu, Al, and Au in a mixing ratio of 64 (Cu): 23 (Al): 13 (Au), a protective layer having a thickness of approximately 5 nm and composed of Si, and a dielectric layer having a thickness of approximately 30 nm and made of TiO₂ (titanium dioxide) are formed in the order mentioned from the spacer layer side.

Then, a light transmitting layer having a thickness of approximately 75 μm was formed on the second information layer. The UV curable resin composition used for the light emitting layer included 50% by mass of urethane acrylate (manufactured by Negami Chemical Industrial Co., Ltd. under the trade name of “Art Resin UN-5200”), 33% by mass of trimethylolpropane triacrylate (manufactured by NIPPON KAYAKU Co., LTD. under the trade name of “KAYARAD TMPTA), 14% by mass of phenoxyhydroxypropyl acrylate (manufactured by NIPPON KAYAKU Co., LTD. under the trade name of “KAYARAD R-128”), and 3% by mass of 1-hydroxycyclohexylphenylketone (manufactured by Ciba Specialty Chemicals Corporation under the trade name of “IRG 184”).

Then, the light transmitting layer was spin-coated with a hard coat agent, and a dilution solvent inside the coating was removed by heating the layer for about three minutes at 60° C. in the atmosphere. Then, the layer is irradiated with ultraviolet light and a hard coat layer having a thickness of approximately 2 μm after the curing was formed.

The composition of the hard coat agent included 50% by mass of reactive group modified colloidal silica (in dispersion medium of propyleneglycol monomethyl ether acetate and with 40% by mass of solid content), 22% by mass of dipentaerythritol hexaacrylate (manufactured by NIPPON KAYAKU Co., LTD. under the trade name of “KAYARAD DPHA”), 5% by mass of tetrahydrofurfryl acrylate (manufactured by KYOEISHA CHEMICAL Co., LTD under the trade name of “THF-A”), 20% by mass of propyleneglycol monomethyl ether acetate (non-reactive diluent), and 3% by mass of 1-hydroxycyclohexylphenylketone (manufactured by Ciba Specialty Chemicals Corporation under the trade name of “IRG 184”).

Then, the disc is reversed and a warpage adjusting layer having a thickness of approximately 10 μm was formed on the substrate surface opposite to the recording surface.

The UV curable resin composition used for the warpage adjusting layer included 26% by mass of dicyclopentanyl acrylate (manufactured by Hitachi Chemical Co., Ltd. under the trade name of “FA-513A”), 13% by mass of 1,6-hexyanediol diacrylate (manufactured by NIPPON KAYAKU Co., LTD. under the trade name of “KARAYAD HDDA”), 55% by mass of pentaerythritol triacrylate (manufactured by NIPPON KAYAKU Co., LTD. under the trade name of “KARAYAD PET-30”), and 6% by mass of 2-methyl-1-[4-(methylthio) phenyl]-2-morpholinopropane-1 (manufactured by Ciba Specialty Chemicals Corporation under the trade name of “IRG 907”).

A moisture proof layer having a thickness of approximately 50 nm and composed of ZnS (zinc sulfide) and SiO₂ (silicon dioxide) mixed in a mixture ratio of 80 (ZnS): 20(SiO₂) was formed on the warpage adjusting layer.

Then, a warpage preventing layer having a thickness of approximately 75 nm was formed on the moisture proof layer. The material used for the warpage preventing layer was the same material for the light transmitting layer.

Then, the warpage preventing layer was provided with UV curable white ink for screen printing, “DVC-616 white” (trade name) manufactured by Teikoku Printing Inks Mfg. Co., Ltd. as a label printing layer by screen printing.

Two such optical recording media (Examples 1 and 2) each provided with the warpage adjusting layer and then the moisture proof layer in the above described manner were placed in an environment at 25° C. and with a humidity of 95%, and saturated with sufficient moisture. Then, these discs were placed in an environment at 25° C. and with a humidity of 45%, and the optical recording media according to Examples 1 and 2 were measured for changes in their warpage angles when there were abrupt changes in humidity. The changes in the warpage angles were measured using a high precision laser angle measuring device “LA-2000” (trade name) manufactured by Keyence Corporation. The samples were each set in the measuring device and the warpage angle at a point 58 mm from the center of the sample was measured.

Comparative Examples 1 and 2 having a moisture proof layer and a warpage adjusting layer formed in the reversed order from the above described optical recording media were produced, and they were measured for changes in their warpage angles with humidity changes.

The measurement results are given in FIG. 5. As can clearly be understood from the results about the warpage angles, changes in the warpage angles can be reduced by forming the warpage adjusting layer first.

What is claimed is:

1. An optical recording medium comprising:
a substrate;
a recording layer and a light transmitting layer provided on one surface of the substrate;
a warpage adjusting layer provided on the other surface of the substrate; and
a moisture proof layer provided on the warpage adjusting layer.

2. The optical recording medium according to claim 1, wherein
the warpage adjusting layer is formed of a UV curable resin.

3. An optical recording medium comprising:
a substrate;
a recording layer provided on one surface of the substrate and including at least two information layers and a spacer layer provided between the information layers, the spacer layer being formed of a UV curable resin;
a light transmitting layer provided on the recording layer;
a warpage adjusting layer provided on the other surface of the substrate; and
a moisture proof layer provided on the warpage adjusting layer.

4. The optical recording medium according to claim 3, wherein
the spacer layer comprises:
a transfer layer formed of a UV curable resin having a glass transition point Tg of at least 80° C.; and
an adhesion layer formed of a UV curable resin having a glass transition point Tg of less than 100° C., the adhesion layer adhering the transfer layer to the information layer.

5. The optical recording medium according to claim 1, further comprising a label printing layer provided on a surface of the moisture proof layer opposite to the warpage adjusting layer.

6. The optical recording medium according to claim 2, further comprising a label printing layer provided on a surface of the moisture proof layer opposite to the warpage adjusting layer.

7. The optical recording medium according to claim 3, further comprising a label printing layer provided on a surface of the moisture proof layer opposite to the warpage adjusting layer.

8. The optical recording medium according to claim 4, further comprising a label printing layer provided on a surface of the moisture proof layer opposite to the warpage adjusting layer.

9. The optical recording medium according to claim 5, further comprising a warpage preventing layer provided between the moisture proof layer and the label printing layer, for keeping moisture absorption to and releasing from the light transmitting layer in balance.

10. The optical recording medium according to claim 6, further comprising a warpage preventing layer provided between the moisture proof layer and the label printing layer, for keeping moisture absorption to and releasing from the light transmitting layer in balance.

11. The optical recording medium according to claim 7, further comprising a warpage preventing layer provided between the moisture proof layer and the label printing layer, for keeping moisture absorption to and releasing from the light transmitting layer in balance.

12. The optical recording medium according to claim 8, further comprising a warpage preventing layer provided between the moisture proof layer and the label printing layer, for keeping moisture absorption to and releasing from the light transmitting layer in balance.
